(19) United States
(12) Patent Application Publication
(10) Pub. No.: US 2026/0121697 A1
(43) Pub. Date: Apr. 30, 2026

(54) MULTI-INPUT MULTI-OUTPUT ORTHOGONAL FREQUENCY DIVISION MULTIPLEXING COMMUNICATION SYSTEM AND CHANNEL TRACKING CONTROL METHOD THEREOF

(71) Applicant: REALTEK SEMICONDUCTOR CORPORATION, HSINCHU (TW)

(72) Inventor: CHUN-CHIEH TSENG, HSINCHU (TW)

(21) Appl. No.: 19/348,246

(22) Filed: Oct. 2, 2025

(30) Foreign Application Priority Data
Oct. 29, 2024 (TW) 113141368

(51) Int. Cl. H04B 7/0413; H04L 5/00; H04L 25/02

(52) U.S. Cl. CPC H04B 7/0413; H04L 5/0007; H04L 5/0098; H04L 25/0204

(57) ABSTRACT

A channel tracking control method, applied to a multiple-input multiple-output orthogonal frequency-division multiplexing communication system, includes the following operations: during a preamble period of a packet, determining a noise power according to a preamble of the packet, in which the preamble is transmitted via sub-carriers; during the preamble period, determining a clipping level value corresponding to a sub-carrier in the sub-carriers according to a noise reduction factor of a channel detection circuit; during the preamble period, determining a signal-to-noise ratio of the sub-carrier according to the clipping level value and the noise power; and according to the signal-to-noise ratio and a target signal-to-noise ratio, controlling a channel tracking circuit to stop tracking a channel response of the sub-carrier during a payload period of the packet.

### BACKGROUND OF THE INVENTION

### 1. Field of the Invention

The present disclosure relates to a multiple-input multiple-output (MIMO) orthogonal frequency-division multiplexing (OFDM) communication system, and more particularly to a MIMO OFDM communication system and a channel tracking control method thereof that may avoid power consumption during disabled period by selectively enabling a channel tracking mechanism.

### 2. Description of Related Art

In an orthogonal frequency-division multiplexing communication system, each OFDM symbol is composed of a plurality of sub-carriers. Conventional channel tracking mechanism of existing orthogonal frequency-division multiplexing communication systems continuously tracks the channel responses of sub-carriers during a payload period of a packet, to ensure that the receiver can decode correctly the data on these sub-carriers. However, in packet-based transmission systems with low mobility, the preamble has already revealed sufficiently the quasi-static channel information of each sub-carrier (per-tone). Apparently, such a conventional blind and continuous (always-on) channel tracking mechanism during payload period will result in waste of unnecessary power consumption.

### SUMMARY OF THE INVENTION

In some aspects of the present disclosure, an object of the present disclosure is, but not limited to, to provide a multiple-input multiple-output orthogonal frequency-division multiplexing communication system and a channel tracking control method thereof that may improve power saving by observing whether the signal-to-noise ratio of each sub-carrier in the preamble is sufficient and selectively enabling the channel tracking mechanism, so as to make an improvement to the prior art.

In some aspects of the present disclosure, a channel tracking control method, which is applied to a multiple-input multiple-output orthogonal frequency-division multiplexing communication system, includes the following operations: during a preamble period of a packet, determining a noise power according to the preamble of the packet, wherein the preamble is transmitted via a plurality of sub-carriers; during the preamble period, determining a clipping level value corresponding to a sub-carrier in the plurality of sub-carriers according to a noise reduction factor of a channel detection circuit; during the preamble period, determining a signal-to-noise ratio of the sub-carrier according to the clipping level value and the noise power; and according to the signal-to-noise ratio and a target signal-to-noise ratio, controlling a channel tracking circuit to stop tracking a channel response of the sub-carrier during a payload period of the packet.

In some aspects of the present disclosure, a multiple-input multiple-output orthogonal frequency-division multiplexing communication system includes a noise power estimation circuit, a channel detection circuit, and a control circuit. The noise power estimation circuit is configured to determine a noise power during a preamble period of a packet according to a preamble of the packet, wherein the preamble is transmitted via a plurality of sub-carriers. The channel detection circuit is configured to provide a noise reduction factor. The control circuit is configured to determine a clipping level value corresponding to a sub-carrier in the plurality of sub-carriers during the preamble period according to the noise reduction factor, determine a signal-to-noise ratio of the sub-carrier according to the clipping level value and the noise power, and control a channel tracking circuit to stop tracking a channel response of the sub-carrier during a payload period of the packet according to the signal-to-noise ratio and a target signal-to-noise ratio.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a multiple-input multiple-output (MIMO) orthogonal frequency-division multiplexing (OFDM) communication system according to some embodiments of the present disclosure.

FIG. 2 illustrates a schematic diagram of the detection circuitry in FIG. 1 according to some embodiments of the present disclosure.

FIG. 3 illustrates a schematic diagram of a probability density function obtained by taking the absolute value squared of the complex Gaussian distribution of the initial tracking eh according to some embodiments of the present disclosure.

FIG. 4 illustrates a flowchart of a channel tracking control method according to some embodiments of the present disclosure.

FIG. 5 illustrates a schematic diagram of a module of a channel tracking control mechanism according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system formed with one or more circuits, and the term “circuit” may indicate an object, which is formed with one or more transistors and/or one or more active/passive elements according to a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, like elements in various figures are designated with the same reference number.

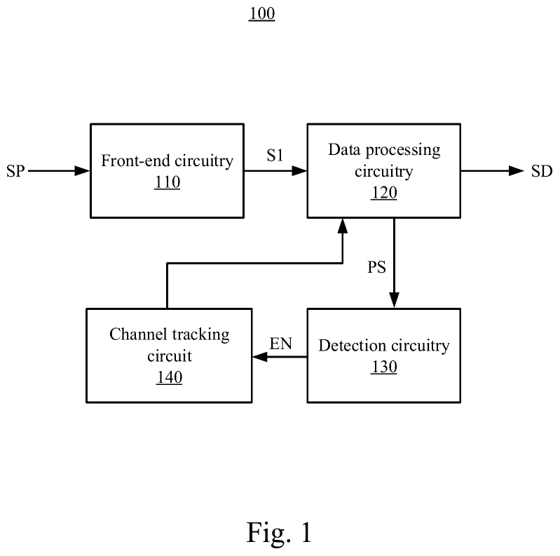

FIG. 1 illustrates a schematic diagram of a multiple-input multiple-output (MIMO) orthogonal frequency-division multiplexing (OFDM) communication system 100 according to some embodiments of the present disclosure. For simplification, FIG. 1 mainly illustrates the receiver portion of the MIMO OFDM communication system 100. It may be understood that, in different embodiments, the MIMO OFDM communication system 100 may also include a transmitter portion that transmits packets or data. The MIMO OFDM communication system 100 includes a front-end circuitry 110, a data processing circuitry 120, a detection circuitry 130, and a channel tracking circuit 140. The front-end circuitry 110 is configured to receive a packet SP and perform front-end signal processing (which may include, for example, but not limited to signal amplification, filtering, down-conversion, analog-to-digital conversion, etc.) on the packet SP to generate a signal S1. The data processing circuitry 120 performs a data processing based on the signal S1 (for example, including but not limited to cyclic prefix removal, fast Fourier transform, equalization processing, demodulation, decoding, etc.) to obtain data SD carried in the packet SP. The detection circuitry 130 obtains the preamble symbol PS in the packet SP from the data processing circuitry 120 during the preamble symbol period of the packet SP, and determines whether to generate an enable signal EN to control the channel tracking circuit 140 to track a channel response corresponding to each sub-carrier of the packet SP during the payload period. The data processing circuitry 120 may update its internal parameters based on the channel response tracked by the channel tracking circuit 140 to adjust the data processing (for example, including but not limited to the aforementioned equalization processing).

It is understood that in an OFDM system, the data of the packet SP will be transmitted via all (or part of) the sub-carriers. Each sub-carrier corresponds to a channel. In order to ensure that the data carried by the packet SP can be correctly read, the channel tracking circuit 140 may track (estimate) the channel response corresponding to each sub-carrier and provide the obtained channel response information to the data processing circuitry 120, so that the data processing circuitry 120 may update internal parameters based on the channel response information. The detection circuitry 130 may determine, according to the preamble symbol PS in the packet SP, whether to generate the enable signal EN during a payload period of the packet SP to control the channel tracking circuit 140 to perform channel tracking on each sub-carrier. In other words, a per-tone channel tracking mechanism may be implemented with the detection circuitry 130 and the channel tracking circuit 140, in which the aforementioned per-tone refers to the frequency of each sub-carrier. For ease of illustration, the following example will describe the operation of selectively tracking a channel of a corresponding sub-carrier (hereinafter referred to as the first sub-carrier) in all sub-carriers, according to the calculation of a preamble symbol PS in the packet SP by the detection circuitry 130.

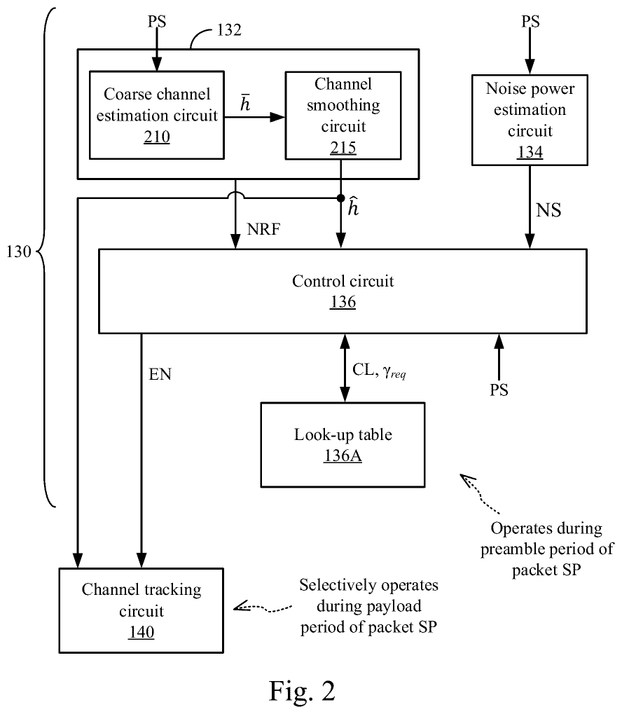

FIG. 2 illustrates a schematic diagram of the detection circuitry 130 in FIG. 1 according to some embodiments of the present disclosure. In some embodiments, the detection circuitry 130 may determine a noise power according to the preamble symbol PS during the preamble period, and determine whether to control the channel tracking circuit 140 to stop tracking the channel response of the first sub-carrier during the payload period according to a noise reduction factor associated with the detection circuitry 130. For example, the detection circuitry 130 may include a channel detection circuit 132, a noise power estimation circuit 134, and a control circuit 136. The channel detection circuit 132 is configured to track the channel response of the first sub-carrier during the preamble period (which may be, for example, the estimated channel response ĥ described later), in which the preamble symbol PS is transmitted the plurality of (for example, all) sub-carriers and may correspond to sub-carriers of OFDM symbols during the payload period of the packet SP. The noise power estimation circuit 134 is configured to determine a noise power NS (equivalent to

$$2 \times {σ}_{n}^{2} )$$

according to the variance

$${σ}_{n}^{2}$$

related to noise and the preamble symbol PS. The control circuit 136 is configured to determine a clipping level (or may be referred to as “confident level”) value CL corresponding to the first sub-carrier according to a noise reduction factor NRF provided by the channel detection circuit 132. The control circuit 136 may determine the signal-to-noise ratio (SNR) corresponding to the first sub-carrier according to the clipping level value CL and the noise power NS, and output the enable signal EN according to this SNR (equivalent to equation (8) described later) and a target SNR γ_{reg}, so as to selectively control the channel tracking circuit 140 to stop tracking the channel response of the first sub-carrier during the payload period of the packet SP. In some embodiments, when the channel tracking circuit 140 continues to track the channel response of the first sub-carrier during the payload period according to the enable signal EN, the channel tracking circuit 140 may continue to track the channel response of the first sub-carrier according to the estimated channel response ĥ generated by the channel detection circuit 132. In some embodiments, the control circuit 136 may be implemented with a signal processing circuit that performs the mathematical operations described later. In some embodiments, the relevant operations of the control circuit 136 may be implemented with the network controller and/or corresponding software/firmware that performs these mathematical operations in cooperation.

In some embodiments, the noise power estimation circuit 134 may be implemented with a digital circuit with computing capability. In some embodiments, the noise power estimation circuit 134 may use maximum likelihood estimation (MLE) algorithm, minimum mean-square error (MMSE) algorithm, or other methods to estimate the variance

$${σ}_{n}^{2}$$

according to the preamble symbol PS to determine the noise power NS. The estimation method of the noise power estimation circuit 134 described above is given for illustrative purposes, and the present disclosure is not limited thereto. The method of estimating noise power is understood by a person having ordinary skill in the art, and thus is not described in further detail herein.

The channel detection circuit 132 includes a coarse channel estimation circuit 210 and a channel smoothing circuit 215. The coarse channel estimation circuit 210 is configured to determine a coarse channel response h̅ according to the preamble symbol PS received at different times. In some embodiments applied to Wi-Fi systems, the coarse channel estimation circuit 210 may determine the coarse channel response by averaging two long training fields (LTF) in the preamble symbol PS, but the present disclosure is not limited thereto. The channel smoothing circuit 215 is configured to filter the coarse channel response h̅ to generate the estimated channel response ĥ. In some embodiments, the channel smoothing circuit 215 may be implemented with a finite impulse response (FIR) filter, but the present disclosure is not limited thereto. Combined with the noise power estimation, the noise power of the obtained estimated channel response may be known, which is described as follows.

The following illustrates the related mathematical model of the detection circuitry 130. First, by observing the long training field of the preamble symbol PS on a per-tone basis, it may be assumed that the preamble symbol PS received at the first time and the second time (both transmitted by sub-carriers of the same frequency) satisfies the following equation (1):

$$\{ \begin{matrix}{y}_{1} ≡ h \cdot {x}_{1} + {n}_{1} , {n}_{1} , {n}_{2} ∼ CN ( 0 , {σ}_{n}^{2} ) \\ {y}_{2} ≡ h \cdot {x}_{2} + {n}_{2} , {x}_{1} , {x}_{2} ∈ [ + 1 , - 1 ]\end{matrix} \qquad ( 1 )$$

where γ₁ is the preamble symbol PS received at the first time, γ₂ is the preamble symbol PS received at the second time, h is the actual channel response of the first sub-carrier, and n₁ and n₂ are the channel noise corresponding to the first sub-carrier, which is satisfied with a complex Gaussian distribution with a mean of 0 and a variance of

$${σ}_{n}^{2}$$

(denoted as

$$C N ( 0 , {σ}_{n}^{2} ) ) .$$

x₁ and x₂ are known data values of the preamble symbol PS at the first time and the second time, and their values are +1 or −1.

In some embodiments, the coarse channel estimation circuit 210 may estimate the coarse channel response h̅ according to equation (1) above by using the preamble symbol PS. For example, both sides of the mathematical equation regarding y₁ in equation (1) are multiplied by x₁, both sides of the mathematical equation regarding y₂ are multiplied by x₂, and the results of these two operations are summed and averaged to derive that the coarse channel response h̅ satisfies the following equation (2), where the effect of x₁ and x₂ on noise n₁ and noise n₂ is ignored in equation (2) (as x₁ and x₂ are constants of +1 or −1, x₁ and x₂ will not change the statistical properties of noise n₁ and noise n₂):

$$\overline{h} ≡ \frac{( {y}_{1} {x}_{1} + {y}_{1} {x}_{1} )}{2} + \overline{n} = h + \overline{n} \overline{n} ≡ \frac{{n}_{1} + {n}_{2}}{2} ∼ CN ( 0 , {β}_{L T F} \cdot {σ}_{n}^{2} ) , {β}_{L T F} = 0.5 \qquad ( 2 )$$

where noise n̅ satisfies a complex Gaussian distribution with a mean of 0 and a variance of

$${β}_{L T F} \cdot {σ}_{n}^{2} ,$$

and β_{LTF} corresponds to the noise reduction factor of the coarse channel estimation circuit 210 on the noise of the preamble symbol PS (e.g., noise n₁ and noise n₂), with a value of 0.5 (that is, the sum of noise n₁ and noise n₂ is reduced by 0.5 times as shown in equation (2)). According to the definition of equation (2), the variance n̅ is half of the variance of n₁ and n₂.

Next, the estimated channel response ĥ generated by the channel smoothing circuit 215 according to the coarse channel response h̅ satisfies the following equation (3):

$$\hat{h} ≡ h - {e}_{h} , {e}_{h} ∼ CN ( 0 , β \cdot {σ}_{n}^{2} ) \qquad ( 3 )$$

where eₕ is the initial tracking error, which satisfies a complex Gaussian distribution with a mean of 0 and a variance of

$$β \cdot {σ}_{n}^{2} .$$

β is the noise reduction factor NRF of the channel detection circuit 132, which may be the product of the noise reduction factor B_{LTF} of the coarse channel estimation circuit 210 and the noise reduction factor B_{FIR} of the channel smoothing circuit 215 (that is, β=β_{LTF}×β_{FIR}), and h is the actual channel response of the first sub-carrier. That is, an initial tracking error eₕ exists between the estimated channel response ĥ and the actual channel response h of the first sub-carrier, and the noise reduction factor NRF may be the total noise reduction factor of the coarse channel estimation circuit 210 and the channel smoothing circuit 215 on the noise of the preamble symbol PS. In some embodiments, the noise reduction factor β_{FIR} of the channel smoothing circuit 215 may be derived in advance during the circuit design stage based on the filter parameters (for example, which may include, but not limited to, filter order, coefficients) of the channel smoothing circuit 215. In some embodiments, the value of the noise reduction factor NRF may be preset and stored in a register (not shown) of the control circuit 136. In some embodiments, the initial tracking error eₕ may be, but is not limited to, residual noise (e.g., the attenuated noise n₁ and noise n₂) causing channel estimation error to the channel estimation mechanism (e.g., the channel detection circuit 132). Therefore, the initial tracking error eₕ also satisfies the aforementioned complex Gaussian distribution (the same distribution as that corresponding to noise n₁ and noise n₂).

The following derives the impact of the initial tracking error eₕ on the signal-to-noise ratio. First, from the previous derivation, it may be known that by observing the preamble symbol PS of the packet SP on a per-tone basis, the preamble symbol PS of the packet SP may be expressed as the following equation (4):

$$y ≡ h \cdot x + n , n ∼ CN ( 0 , {σ}_{n}^{2} ) \qquad ( 4 )$$

where y may correspond to the aforementioned y₁ or y₂, x may correspond to the aforementioned x₁ or x₂, h is the channel response of the first sub-carrier, and n may correspond to the aforementioned noise n₁ or noise n₂. Furthermore, as noise n satisfies a complex Gaussian distribution, the noise power of noise n is the sum of the power of its real part (for example,

$${σ}_{n}^{2} )$$

and the power of its imaginary part (for example,

$${σ}_{n}^{2} ) ,$$

which may be expressed as the following equation (5):

$$E [ {\vert n \vert}^{2} ] = 2 \cdot {σ}_{n}^{2} \qquad ( 5 )$$

If equation (3) is substituted into equation (4), it may further derive that the noise power of noise n satisfies the following equation (6):

$${\hat{σ}}_{n}^{2} ≡ E [ {\vert y - \hat{h} \cdot x \vert}^{2} ] = E [ {\vert {e}_{h} \vert}^{2} ] + E [ {\vert n \vert}^{2} ] = 2 \cdot {σ}_{n}^{2} \cdot ( 1 + β ) \qquad ( 6 )$$

In some embodiments, the derivation related to equation (6) applies two simplification conditions: (1) the mean of noise n is 0; and (2) the data value x and the initial tracking error eₕ are independent, and E[|x|²] may be simplified as 1 (assuming the power of x has been normalized).

According to equation (4), it may derive that the signal power S of the preamble symbol PS satisfies the following equation (7):

$$S ≡ E [ {\vert h \cdot x \vert}^{2} ] = E [ {\vert h \vert}^{2} ] \cdot E [ {\vert x \vert}^{2} ] = E [ {\vert h \vert}^{2} ] \qquad ( 7 )$$

Therefore, according to equation (6) and equation (7), the signal-to-noise ratio γ of the first sub-carrier satisfies the following equation (8):

$$γ ≡ \frac{s}{{\hat{σ}}_{n}^{2}} = \frac{S}{{σ}_{T}^{2} + 2 {σ}_{n}^{2}} = \frac{S}{β \cdot 2 {σ}_{n}^{2} + 2 {σ}_{n}^{2}} = \frac{S}{2 \cdot {σ}_{n}^{2}} \cdot \frac{1}{1 + β} = \frac{{γ}_{o}}{1 + β} \qquad ( 8 )$$

where γ₀ is

$$\frac{S}{2 \cdot {σ}_{n}^{2}} ,$$

which is the expected signal-to-noise ratio not affected by the channel estimation error, and

$${σ}_{T}^{2}$$

is the variance of the channel estimation error, which may be expressed as the following equation (9):

$${σ}_{T}^{2} ≡ E [ {\vert {e}_{h} \vert}^{2} ] = β \cdot 2 {σ}_{n}^{2} \qquad ( 9 )$$

From equation (8), it may be understood that if the channel detection circuit 132 generates the channel estimation error due to the impact of noise(s), the expected signal-to-noise ratio γ₀ will be reduced by a factor of 1+β.

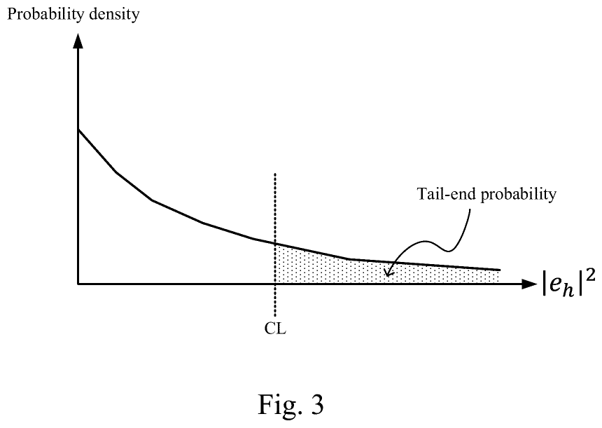

In some embodiments, the initial tracking error eₕ may be a fixed value during the processing of the packet SP (that is, for all OFDM symbols, the value of the initial tracking error eₕ is fixed). As described above, the initial tracking error eₕ satisfies the complex Gaussian distribution in equation (3). In order to further understand the statistical characteristics of the absolute value squared of the initial tracking error eₙ (that is, |eₕ|²) (due to equation (4)), the complex Gaussian distribution may be further taken to the absolute value squared. Reference is made to FIG. 3, which illustrates a schematic diagram of a probability density function obtained by taking the absolute value squared of the complex Gaussian distribution of the initial tracking en according to some embodiments of the present disclosure. As shown in FIG. 3, if the initial tracking error eₕ in equation (3) is taken to the absolute value squared, a central chi-square distribution with 2 degrees of freedom is obtained, which shows a long-tailed probability distribution.

Based on equation (3), it may be understood that this probability density function may be a function of the noise reduction factor NRF (that is, β in equation (3)) of the channel detection circuit 132 and the variance

$${σ}_{n}^{2}$$

of noise n. As shown in FIG. 3, the initial tracking error eₙ still has a certain probability of being infinitely large (although the probability is very low). In order to simplify the calculation, the absolute value squared of the initial channel error eₕ may be set to a clipping level value CL. In some embodiments, the clipping level value CL is configured to indicate a tail-end probability limit value of the initial tracking error eₕ. That is, an initial tracking error en exceeding the clipping level value CL is regarded as within a tolerable error range (corresponding to a smaller probability distribution, for example, the hatched area in FIG. 3), and the clipping level value CL may be regarded as the worst-case scenario in a larger probability distribution of the initial channel error eₕ.

Therefore, based on the aforementioned reasoning as well as equation (8) and equation (9), the signal-to-noise ratio γ may be derived to satisfy the following equation (10):

$$γ = \frac{S}{2 {σ}_{n}^{2} + {\vert {e}_{h} \vert}^{2}} > \frac{S}{2 {σ}_{n}^{2} + C L} , 0 \leq {\vert {e}_{h} \vert}^{2} \leq CL \qquad ( 10 )$$

As shown in FIG. 3, when the absolute value squared of the initial tracking error eₕ is smaller than the clipping level value CL, the signal-to-noise ratio γ becomes larger; when the absolute value squared of the initial tracking error eₕ equals the clipping level value CL, the signal-to-noise rat γ io is the worst-case scenario set in advance. Therefore, the control circuit 136 may estimate the worst-case SNR through the clipping level value CL.

Accordingly, according to equation (10), the condition for the control circuit 136 to stop channel tracking may be expressed as the following equation (11):

$$γ > \frac{S}{2 {σ}_{n}^{2} + C L} > {γ}_{r e q} \qquad ( 11 )$$

In equation (11), γ_{reg} is the target signal-to-noise ratio. In some embodiments, different tail-end probabilities may be set according to the modulation scheme of the preamble symbol PS, so as to set the corresponding clipping level value CL. For example, if the modulation scheme is high-order quadrature amplitude modulation (QAM), the tail-end probability may be set as a lower probability, so a larger clipping level value CL will be set. Alternatively, if the modulation scheme is low-order QAM, the tail-end probability may be set as a higher probability, so a smaller clipping level value CL will be set.

In some embodiments, the control circuit 136 may search a look-up table 136A to obtain information on the clipping level value CL and the target signal-to-noise ratio γ_{req}. The look-up table 136A is configured to indicate the correspondence between the noise reduction factor NRF (that is, β in equation (3)) of the channel detection circuit 132, the clipping level value CL (or the aforementioned corresponding tail-end probability limit value), and the target signal-to-noise ratio γ_{reg}. In some embodiments, the aforementioned related mathematical operations may be performed offline to generate the look-up table 136A, and the look-up table 136A is pre-stored in the control circuit 136 or stored in an additional memory circuit (not shown). The control circuit 136 may search the look-up table 136A according to the noise reduction factor NRF (which may be known at the design stage in advance) to obtain the clipping level value CL and the target signal-to-noise ratio Y_{reg} corresponding to the current system application requirements, and perform the operation of equation (11) to determine whether the signal-to-noise ratio of the preamble symbol PS is greater than the target signal-to-noise ratio γ_{reg}. If the signal-to-noise ratio γ is greater than the target signal-to-noise ratio γ_{req}, the control circuit 136 may output the enable signal EN to control the channel tracking circuit 140 to stop tracking the channel response of the first sub-carrier during the payload period of the packet SP, thereby saving overall power consumption. Alternatively, if the signal-to-noise ratio γ is not greater than the target signal-to-noise ratio γ_{reg}, the control circuit 136 may output the enable signal EN to control the channel tracking circuit 140 to continue tracking the channel response of the first sub-carrier during the payload period of the packet SP, so as to ensure that the MIMO OFDM communication system 100 is able to correctly receive symbols or data transmitted via the first sub-carrier.

In some embodiments, based on equation (7) and equation (11), the control circuit 136 may determine the signal-to-noise ratio γ according to the following operations: determining a value (which may, for example, be expressed as

$$2 {σ}_{n}^{2} + C L )$$

according to the noise power NS determined by the noise power estimation circuit 134 (equivalent to

$$2 {σ}_{n}^{2}$$

in the aforementioned equations) and the clipping level value CL; and dividing a signal power of the preamble symbol PS (for example, the signal power S in equation (7) may be calculated using the estimated channel response h) by this value to determine the signal-to-noise ratio γ (that is,

$$\frac{S}{2 {σ}_{n}^{2} + C L}$$

in equation (11)).

In some embodiments, equation (11) may be further adjusted based on equation (8) as the following equation (12):

$$γ > \frac{S}{2 {σ}_{n}^{2} + C L} = {γ}_{0} \cdot \frac{1}{1 + CL / 2 {σ}_{n}^{2}} > {γ}_{r e q} \qquad ( 12 )$$

In other embodiments, the control circuit 136 may determine the signal-to-noise ratio γ according to the following operations: determining an expected signal-to-noise ratio (that is, γ₀ in equation (12)) according to the noise power NS determined by the noise power estimation circuit 134 (equivalent to

$$2 {σ}_{n}^{2}$$

in the aforementioned equations) and a signal power of the preamble symbol (for example, the signal power S in equation (7) may be calculated using the estimated channel response h); and determining the signal-to-noise ratio γ (that is, equation (12)) according to the expected signal-to-noise ratio, the noise power NS, and the clipping level value CL.

The above-mentioned operations are described for the channel response of one sub-carrier. As described above, the channel tracking of the detection circuitry 130 is a per-tone channel tracking mechanism. Therefore, the detection circuitry 130 may determine whether to control the channel tracking circuit 140 to selectively stop tracking the channel response of each sub-carrier during the payload period of the packet SP based on the same operations, thereby avoiding excessive power consumption.

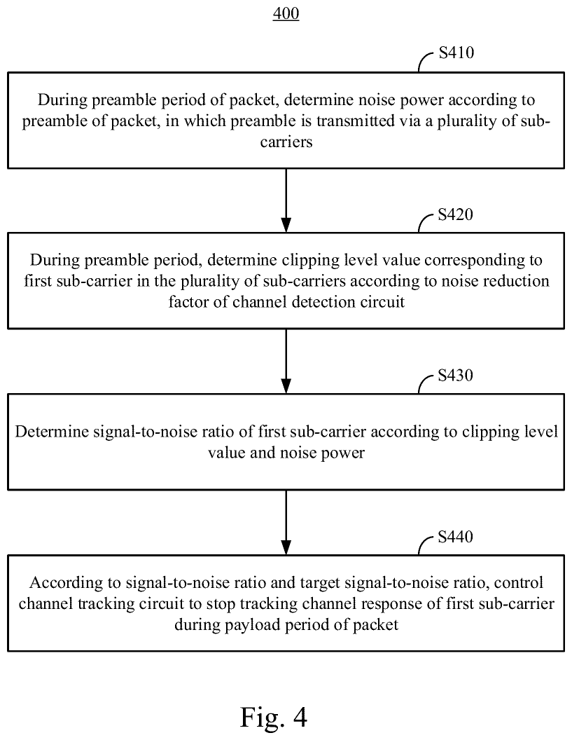

FIG. 4 illustrates a flowchart of a channel tracking control method 400 according to some embodiments of the present disclosure. In some embodiments, the channel tracking control method 400 may be applied to the MIMO OFDM communication system 100 in FIG. 1, but the present disclosure is not limited thereto. In operation S410, during a preamble period of a packet, a noise power is determined according to a preamble of the packet, in which the preamble is transmitted via a plurality of sub-carriers. In operation S420, during the preamble period, a clipping level value corresponding to a first sub-carrier in the plurality of sub-carriers is determined according to a noise reduction factor of a channel detection circuit. In operation S430, a signal-to-noise ratio of the first sub-carrier is determined according to the clipping level value and the noise power. In operation S440, according to the signal-to-noise ratio and a target signal-to-noise ratio, a channel tracking circuit is controlled to stop tracking a channel response of the first sub-carrier during the payload period of the packet.

The above operations and/or steps in the channel tracking control method 400 include exemplary operations, but those operations are not necessarily performed in the order described above. Operations and/or steps in the channel tracking control method 400 may be added, replaced, changed order, and/or eliminated. Alternatively, operations and/or steps in the channel tracking control method 400 may be performed simultaneously or partially simultaneously as appropriate, in accordance with the spirit and scope of various embodiments of the present disclosure.

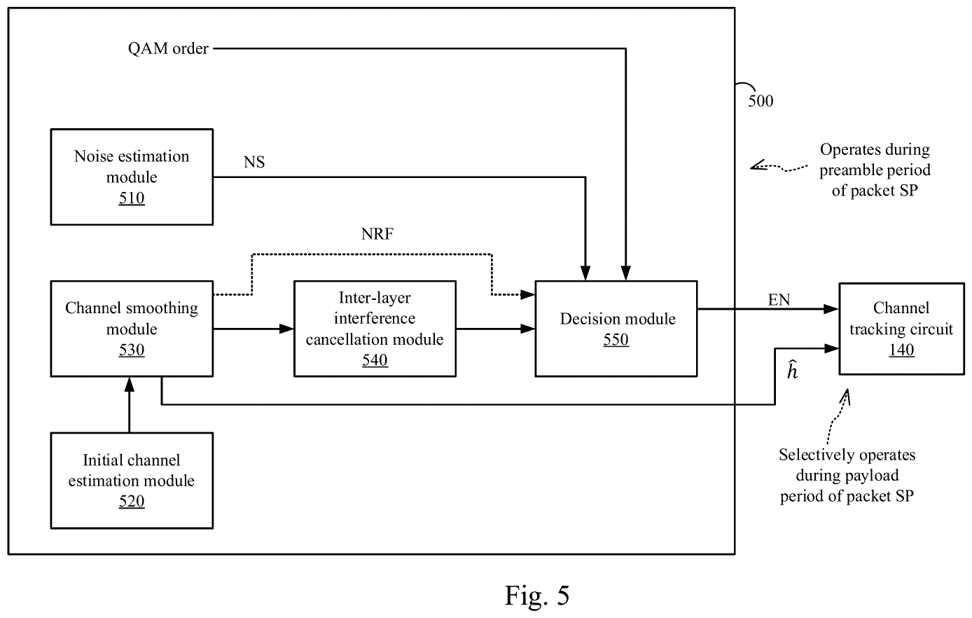

FIG. 5 illustrates a schematic diagram of a module of a channel tracking control mechanism 500 according to some embodiments of the present disclosure. In some embodiments, the channel tracking control mechanism 500 may be executed by the MIMO OFDM communication system 100 in FIG. 1, but the present disclosure is not limited thereto. The channel tracking control mechanism 500 includes a noise estimation module 510, an initial channel estimation module 520, a channel smoothing module 530, an inter-layer interference cancellation module 540, and a decision module 550.

The noise estimation module 510 (which may correspond to the noise power estimation circuit 134 in FIG. 2) is configured to estimate a noise power NS (equivalent to determining the variance

$${σ}_{n}^{2}$$

of noise n). The initial channel estimation module 520 (which may correspond to the coarse channel estimation circuit 210 in FIG. 2) is configured to average two long training fields to provide a noise reduction factor β_{FIR} (with a value of 0.5). The channel smoothing module 530 (which may correspond to the channel smoothing circuit 215 in FIG. 2) is configured to provide a noise reduction factor β_{FIR} (as described above, this reduction factor may be derived in advance based on the filter parameters of the channel smoothing circuit 215). Accordingly, the channel smoothing module 530 may provide a noise reduction factor NRF (that is, β in equation (3)) to the decision module 550. The inter-layer interference cancellation module 540 is configured to eliminate interference from other layer data streams to the signal processed by the initial channel estimation module 520 and the channel smoothing module 530, and output estimated noise level information NL to the decision module 550. The decision module 550 (which may correspond to the control circuit 136 and the look-up table 136A in FIG. 2) may determine whether the signal-to-noise ratio of the first sub-carrier is sufficiently high according to the order of quadrature amplitude modulation (QAM), the variance

$${σ}_{n}^{2}$$

of noise n, the noise reduction factor NRF, and the estimated noise level information NL, so as to determine whether to output the enable signal EN to control the channel tracking circuit 140 to stop tracking the channel response of the first sub-carrier during the payload period of the packet SP. In some embodiments, the channel smoothing module 530 may provide the estimated channel response ĥ to the channel tracking circuit 140, so that when the channel tracking circuit 140 is enabled according to the enable signal EN to continue tracking the channel response of the first sub-carrier during the payload period, the channel tracking circuit 140 may continue to track the channel response of the first sub-carrier according to the estimated channel response ĥ generated by the channel detection circuit 132.

In some embodiments, the calculation flow shown in FIG. 5 has preset the signal power S to be normalized. As shown in FIG. 5, all modules of the channel tracking control mechanism 500 operate during the preamble period of the packet SP, so as to calculate all parameters during this period and determine whether to stop tracking the channel response of the first sub-carrier accordingly. Correspondingly, the channel tracking circuit 140 selectively stops tracking the channel response of the first sub-carrier during the payload period of the packet SP according to the enable signal EN output by the channel tracking control mechanism 500. If the channel tracking control mechanism 500 determines that the signal-to-noise ratio corresponding to the first sub-carrier is sufficiently high, the channel tracking control mechanism 500 may output the enable signal EN to control the channel tracking circuit 140 to stop tracking the channel response of the first sub-carrier during the payload period, so as to save overall system power consumption.

In some embodiments, the various modules shown in FIG. 5 may be implemented with one or more digital circuits. Alternatively, in other embodiments, the various modules shown in FIG. 5 may be implemented with at least one software, and the at least one software is executed by at least one digital signal processing circuit, thereby realizing the corresponding calculation flow.

As described above, the MIMO OFDM communication system and the channel tracking control method thereof provided by some embodiments of the present disclosure may selectively stop the channel tracking mechanism during the payload period of the packet by observing the signal-to-noise ratio of the sub-carriers on a per-tone basis during the preamble period of the packet. As a result, the overall system power consumption can be significantly reduced, thereby improving power saving. By performing coarse estimation and preprocessing of the channel during the preamble period of the packet, and selecting at least one sub-carrier with a higher signal-to-noise ratio based on the calculated signal-to-noise ratio of each sub-carrier, it is able to choose not to perform channel tracking on the at least one sub-carrier during the payload period of the packet, thereby achieving the purpose of power saving.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present disclosure, without any intention to limit the scope of the present disclosure thereto. Various equivalent changes, alterations, or modifications according to the claims of the present disclosure are all consequently viewed as being embraced by the scope of the present disclosure.

What is claimed is:

1. A channel tracking control method, applied to a multiple-input multiple-output orthogonal frequency-division multiplexing communication system, the channel tracking control method comprising:
during a preamble period of a packet, determining a noise power according to a preamble of the packet, wherein the preamble is transmitted via a plurality of sub-carriers;
during the preamble period, determining a clipping level value corresponding to a sub-carrier in the plurality of sub-carriers according to a noise reduction factor of a channel detection circuit;
during the preamble period, determining a signal-to-noise ratio of the sub-carrier according to the clipping level value and the noise power; and
according to the signal-to-noise ratio and a target signal-to-noise ratio, controlling a channel tracking circuit to stop tracking a channel response of the sub-carrier during a payload period of the packet.

2. The channel tracking control method of claim 1, wherein the channel detection circuit comprises a coarse channel estimation circuit and a channel smoothing circuit, and the noise reduction factor is a noise reduction factor of the coarse channel estimation circuit and the channel smoothing circuit on noise of the preamble.

3. The channel tracking control method of claim 1, wherein determining the signal-to-noise ratio of the sub-carrier according to the clipping level value and the noise power during the preamble period comprises:
determining a value according to the noise power and the clipping level value; and
dividing a signal power of the preamble by the value to determine the signal-to-noise ratio.

4. The channel tracking control method of claim 1, wherein determining the signal-to-noise ratio according to the clipping level value and the noise power during the preamble period comprises:
determining an expected signal-to-noise ratio according to the noise power and a signal power of the preamble; and
determining the signal-to-noise ratio according to the expected signal-to-noise ratio, the noise power, and the clipping level value.

5. The channel tracking control method of claim 1, wherein controlling the channel tracking circuit to stop tracking the channel response of the sub-carrier during the payload period according to the signal-to-noise ratio and the target signal-to-noise ratio comprises:
when the signal-to-noise ratio is greater than the target signal-to-noise ratio, controlling the channel tracking circuit to stop tracking the channel response during the payload period; and
when the signal-to-noise ratio is not greater than the target signal-to-noise ratio, controlling the channel tracking circuit to track the channel response during the payload period.

6. The channel tracking control method of claim 1, wherein an initial tracking error exists between an estimated channel response generated by the channel detection circuit and an actual channel response of the sub-carrier, and the clipping level value is configured to indicate a tail-end probability limit value of the initial tracking error.

7. The channel tracking control method of claim 1, wherein determining the clipping level value according to the noise reduction factor of the channel detection circuit during the preamble period comprises:
searching a look-up table according to the noise reduction factor to determine the clipping level value.

8. A multiple-input multiple-output orthogonal frequency-division multiplexing communication system, comprising:
a noise power estimation circuit configured to determine a noise power during a preamble period of a packet according to a preamble of the packet, wherein the preamble is transmitted via a plurality of sub-carriers;
a channel detection circuit configured to provide a noise reduction factor; and
a control circuit configured to determine a clipping level value corresponding to a sub-carrier in the plurality of sub-carriers during the preamble period according to the noise reduction factor, determine a signal-to-noise ratio of the sub-carrier according to the clipping level value and the noise power, and control a channel tracking circuit to stop tracking a channel response of the sub-carrier during a payload period of the packet according to the signal-to- noise ratio and a target signal-to-noise ratio.

9. The multiple-input multiple-output orthogonal frequency-division multiplexing communication system of claim 8, wherein when the signal-to-noise ratio is greater than the target signal-to-noise ratio, the control circuit controls the channel tracking circuit to stop tracking the channel response during the payload period, and when the signal-to-noise ratio is not greater than the target signal-to-noise ratio, the control circuit controls the channel tracking circuit to track the channel response during the payload period.

10. The multiple-input multiple-output orthogonal frequency-division multiplexing communication system of claim 8, wherein the channel detection circuit comprises a coarse channel estimation circuit and a channel smoothing circuit, and the noise reduction factor is a noise reduction factor of the coarse channel estimation circuit and the channel smoothing circuit on noise of the preamble.

11. The multiple-input multiple-output orthogonal frequency-division multiplexing communication system of claim 8, wherein the control circuit is configured to determine a value according to the noise power and the clipping level value, and divide a signal power of the preamble by the value to determine the signal-to-noise ratio.

12. The multiple-input multiple-output orthogonal frequency-division multiplexing communication system of claim 8, wherein the control circuit is configured to determine an expected signal-to-noise ratio according to the noise power and a signal power of the preamble, and determine the signal-to-noise ratio according to the expected signal-to-noise ratio, the noise power, and the clipping level value.

13. The multiple-input multiple-output orthogonal frequency-division multiplexing communication system of claim 8, wherein an initial tracking error exists between an estimated channel response generated by the channel detection circuit and an actual channel response of the sub-carrier, and the clipping level value is configured to indicate a tail-end probability limit value of the initial tracking error.

14. The multiple-input multiple-output orthogonal frequency-division multiplexing communication system of claim 8, wherein the control circuit is configured to search a look-up table according to the noise reduction factor to determine the clipping level value.
